(19) United States
(12) Patent Application Publication
(10) Pub. No.: US 2004/0260715 A1
(43) Pub. Date: Dec. 23, 2004

(54) Object mapping across multiple different data stores

(76) Inventors: Brad A. Mongeon, Exeter, NH (US); Allen F. Hillman III, Loudon, NH (US); Yi Li, Lowell, MA (US); Chris Maeda, Salem, NH (US)

Correspondence Address: FENWICK & WEST LLP, SILICON VALLEY CENTER, 801 CALIFORNIA STREET, MOUNTAIN VIEW, CA, 94041, US

(21) Appl. No.: 10/601,099

(22) Filed: Jun. 20, 2003

(51) Int. Cl. G06F 7/00

(52) U.S. Cl. 707/101

(57) ABSTRACT

An object-oriented system and method is provided that is suitable for creating, reading, updating, and deleting data located across multiple different data stores. Unlike conventional systems, the present invention provides a unified method for access in the form of an UML mapping that ties together multiple databases, rather than using messaging middleware to achieve the same functionality. A virtual object layer provides safe updating, which can easily and automatically handle changes to the Object layer and to the underlying data store layers without the need to recompile or regenerate code.

### BACKGROUND OF THE INVENTION

1. Field of the Invention

The present invention relates generally to data reading and writing across data stores. More specifically, the present invention provides an object-oriented system and method for creating, reading, updating, and deleting data located across multiple different data stores

2. Description of the Related Art

The rapid onset of the information age has meant that the growth of many enterprises, at least from the computer system architecture perspective, has been piecemeal. A company may have started, for example, with a sales division. Later, a customer service division was added. Later still came technical support. With the addition of each division came a new computer system with a different underlying architecture and inherent incompatibilities. Consider other enterprises, in which expansion was the result of mergers and acquisitions. A first Company (A) had a first system architecture, and a second Company (B) had an entirely different architecture. When Company A acquired Company B, it was easier to make do with two incompatible systems than to spend the resources and absorb the risk of merging data from the systems together. Of course, the longer each of the individual systems was relied upon, the more difficult it became to give either of them up.

As a result, many enterprises continue today to operate with multiple system architectures that do not communicate with each other. Referring now to FIG. 1 there is shown an example of a conventional enterprise computer system architecture. FIG. 1 includes a customer server 108 for processing customer data, a sales server 110 for processing orders, and a technical support server 112, for providing technical support services. Each of these servers in turn has an internal data store. As illustrated, customer server 108 includes an Oracle Database 102 for maintaining customer information; sales server 110 includes an SQL Server Database 104 for maintaining order information; and technical support server 112 includes a flat file database 106 for maintaining trouble tickets. Thus, for a sales representative 116 logged in to sales server 110, it is not possible to see both the order information from the Oracle Database 102 and the customer information from the SQL Server Database 104 and customer information in a unified manner.

This communication hurdle is a problem, because in the real world, sales, customer service, technical support and other divisions within an enterprise want (and need) to access data from systems outside of their own divisions. For example, a customer service representative should be able to access sales data for a particular customer, instead of relying on the customer to provide the make and model of their equipment. Similarly, when high value customers call for technical support, some enterprises would like to place those callers at the front of the call queue to minimize their hold time. However if the technical support telephone server cannot access the sales or customer service records, this business goal cannot be implemented. This is a problem well known to those of skill in the art. Indeed, the problem of unified access to disparate data is found in various enterprise environments—sales is but one example.

Communication with databases is typically through the Structured Query Language (SQL). SQL, as is well known in the art, is a database query language adopted as an industry standard in 1986. A major revision to the standard, completed in 1992, is SQL-92 (also known as SQL2). Largely for competitive reasons, vendors have created differing database engines, despite their professed efforts to conform to the SQL-92 standard. Accordingly, SQL database clients cannot use pure SQL statements to access data from multiple vendors' database servers. Instead, system integrators write custom code to point at different sources and present data to a user.

Business applications are typically designed using a layered architecture. Referring now to FIG. 2, an Application Logic layer 202 implements the functionality of the application in terms of operations on an underlying Object layer 204. The Object layer in turn implements the application's objects in terms of code that operates on persistent data that is stored in the Data store layer 206. Each layer of the application implements an interface or language that is used by the layer above it, and that hides irrelevant detail about how the layer is constructed. This use of abstraction or information hiding in software design is analogous to how chemists can think about molecules and their interaction without having to think about how molecules are themselves comprised of atoms held together by electrostatic forces.

A standard solution for allowing multiple business applications to share data is to use Enterprise Application Integration (EAI) technology, in which applications keep redundant copies of the data they need from other applications, and where an EAI module allows messages to be passed between applications when the data changes. In FIG. 3, the logic 306 in Application 1 updates an object 308 which in turn updates the data store 310 that contains data 302 from Application 1, and a copy of data 304 from Application 2. Application 1 sends a message to the EAI module 312 which updates the copy of the data B 314 in Application 2. Some of the main drawbacks of the EAI approach are that it requires both applications to keep redundant copies of the data and that the copies are out of sync for long periods of time while the update messages are in flight. In addition, the applications must be manually adapted to use the EAI technology, and manually modified anytime an application's object layer or data store layer changes-an expensive, labor intensive-process. EAI technology is marketed by a number of vendors, including Tibco, Vitria, SeeBeyond, IBM, BEA, and Microsoft.

Attunity Connect, by Attunity, Inc. of Wakefield, Mass. provides a virtual database layer between the original data store layer and the object layer. As shown in FIG. 4, a virtual data store layer 410 allows the object layer to access and update data 402, 404 in multiple application data stores. When the logic layer in Application 1 406 updates an application object 408, the virtual object layer updates the virtual data store which in turn updates the underlying application data stores 402, 404. The Attunity product allows applications to safely update data in other data stores and automatically handles changes to the underlying data store layer. However, applications must still be manually adapted to use the Attunity product and must be manually modified when an application's object layer changes.

BEA Systems markets a product called Liquid Data that provides a virtual object layer in place of the original object layers in each application. As shown in FIG. 5, when Application 1 accesses an application object 508, the virtual object layer 510 translates the access into accesses on the underlying data stores 502, 504. A key drawback of the Liquid Data technology is that it does not handle updates to the application object; the object may only be read from, not written to, which severely limits the usefulness of this technology.

Firestar Software of Acton, Mass. markets a product called ObjectSpark that provides a virtual object layer that allows the object layer to access and update multiple data stores. Referring now to FIG. 6, when the Application layer 606 updates an object in the Object layer 608, the Object layer 608 updates a local copy of the data 602, 604, and then updates the underlying application data stores 610, 612. The use of redundant copies of data in the Object layer is a key drawback—the redundant copies can easily get out of sync; for example when Application 2 updates its data store 612 without informing Application 1 so that Application 1 can update its copy 604. In addition, ObjectSpark does not handle changes to the Object layer very easily; ObjectSpark requires its virtual objects to be regenerated and recompiled when the Object layer changes.

In view of the foregoing, a need therefore exists for a system and method for providing a virtual object layer with safe updating, which can easily and automatically handle changes to the Object layer and to the underlying data store layers.

### SUMMARY OF THE INVENTION

The present invention provides a solution to the need to aggregate data from multiple sources. Unlike conventional systems, the present invention provides a unified method for access in the form of a UML mapping that ties together multiple databases and an XML API to access the data directly, rather than using messaging middleware to achieve the same functionality.

An Auto Discovery Engine allows a designer to discover tables located on various disparate data stores, and turns table data such as column name, type and size into metadata. From the metadata, the Auto Discovery Engine generates an XML schema, which is saved to an Internal Design Repository.

To access data stored in data objects, a client creates queries that use property sets, filters and views. Database-specific SQL statements are generated by a Database Abstraction Layer. The XML for a query includes in a preferred embodiment a “propertyset” and a “filter.” The propertyset identifies the properties that should be returned as the results of the query and the filter specifies the constraints to place on the results.

In addition, the present invention allows the schema to be updated and automatically reacts to schema changes in underlying data stores. When the schema definition in the Internal Design Repository is changed, the invention automatically modifies the data structures in the underlying data stores to reflect the new definition. When the data structures in the underlying data stores are changed, a Synchronizer module synchronizes the Internal Design Repository with changes in the schemas of the underlying data stores to ensure that data across the multiple data stores is always accessible using an up-to-date schema.

### BRIEF DESCRIPTION OF THE DRAWINGS

FIG. 1 is an example of a conventional enterprise computer system architecture.

FIG. 2 illustrates the conventional architecture of a typical application.

FIG. 3 illustrates a conventional Enterprise Application Integration solution.

FIG. 4 illustrates the conventional use of a virtual data store layer.

FIG. 5 illustrates the conventional use of a virtual object layer.

FIG. 6 illustrates another conventional use of a virtual object layer.

FIG. 7 is a block diagram of a system in accordance with an embodiment of the present invention.

FIG. 8 is a flow chart illustrating a process for automatically generating XML schemas defining relationships between objects from different data stores in accordance with an embodiment of the present invention.

FIG. 9 illustrates a UML (Unified Modeling Language) object model used in accordance with an embodiment of the present invention.

FIG. 10 illustrates how the UML object model maps to a data model in accordance with an embodiment of the present invention.

FIG. 11 illustrates an example of an aggregation that shows a foreign key in accordance with an embodiment of the present invention.

FIG. 12 illustrates a method for creating instances of an object in accordance with an embodiment of the present invention.

The figures depict preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

System Architecture

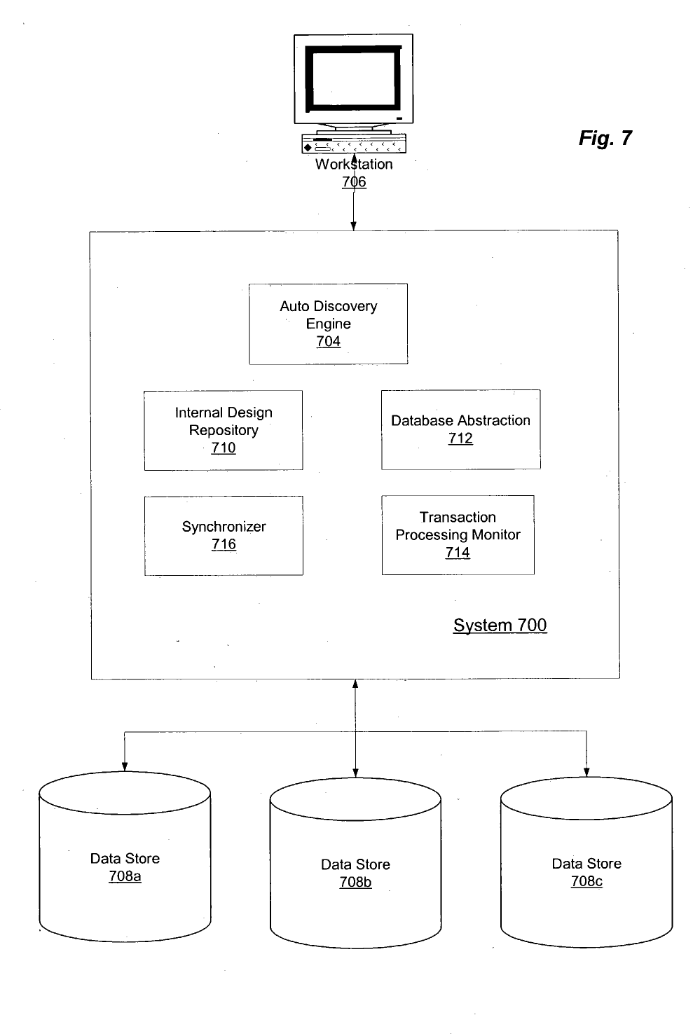

Referring now to FIG. 7, there is shown a diagram of a system 700 in accordance with an embodiment of the present invention. System 700 includes an Auto Discovery Engine 704, which is used to generate appropriate XML Schema based on defined relationships between elements of the various data stores. The Internal Design Repository 710 is where the XML Schema representations are stored. This can be viewed simply as a repository that contains the actual XML Schema, although in practice it may be more efficient to store this information in database tables. The translation from the XML to database tables is a simple task for those of skill in the art, and therefore for the sake of clarity of description, the Schema XML is referred to in this document. Database Abstraction 712 allows access to multiple disparate data sources without writing, compiling and deploying SQL specific code by loading syntactical differences and generating compliant SQL specific code without the use of an if/then/else logical structure. The operation of Database Abstraction 712 is further described below. Transaction Processing Monitor (TP Monitor) is responsible for managing distributed transactions; in particular it coordinates the commitment and rollback of transactions in which the various data stores participate, as will be appreciated by those of skill in the art. System 700 also includes Synchronizer Module 716, which synchronizes the Internal Design Repository 710 with any changes in the schemas of the underlying data stores 708. Data stores 708a, 708b and 708c contain data to be accessed and manipulated by system 700. Note that while three data stores are illustrated in FIG. 7, this is for purposes of illustration and not limitation—fewer or more data stores could be present. Data stores 708 can be relational databases, or non-relational databases with SQL-92 interfaces. If the data store supports distributed transactions then system 700 is able to manipulate the data from that data store in a distributed transaction, however distributed transaction support is not a required attribute of a data store. FIG. 7 also includes a workstation 706, which can be used to create the object requests sent to system 700.

Entities

An “Entity” according to the present invention is the design level description of an Object, similar to a “class” in Java or C++. At design time, the designer works with entity definitions. At run time, the user works with entity instances. Entity definition schema and entity instance data are stored in the Internal Design Repository 710 of system 700. An entity definition schema is preferably an XML representation of the definition's properties and relationships. The XML is used to represent a Unified Modeling Language (UML)-type view of the object model. Those of skill in the art are familiar with the UML specification, which is publicly available from the Object Management Group.

In one embodiment, entity definitions include two types of elements:

Properties—Define the characteristics of the entity definition.

Relationships—Provide a reference to another entity definition.

In other embodiments, entity definitions also include:

Primary Key

a Indexes

Data store ID

Aggregation Information

Association Entity Information

Inheritance

One example of syntax that could be used to define an entity is as follows:

<SilkDataObjects_EntityDirectory_CreateDefinition>

<schema name=“entity-name”>

<!-- elementType block declaring parent -->
<!-- required for derived entity definitions -->
<elementType id=“parent-entity” is=“entity”/>
<!-- relationship block -->
<!-- required for aggregate entity definitions -->
<elementType id=“parent-entity” type=“aggregation”

is=“relationship”>

<element id=“aggregate-from-parent-role”

type=“aggregate-entity”
occurs=“aggregate-from-parent-multiplicity”/>

</elementType>
<!-- property block -- 1 per property -->
<elementType id=“property-name” is=“property”>

<description>field-name</description>
<lexicon/>
<string/>
<dataType dt=“string” maxlength=“integer-value”/>
<!-- additional blocks, depending on property type -->

</elementType>

.
.
.

<!-- layout block -- 1 required -->
<elementType id=“entity-name” is=“entity” virtual=“1|0”>

<description>descriptive text</description>
<element type=“property-name” occurs=“multiplicity”/>

. . . <!-- additional element blocks -->

<datasource password=“realm1” username=“realm1”>

datasource

identifier</datasource>

<dbschema>schema name</dbschema>

<key id=“key-name” type=“key-type”>

<keyPart href=“property-name”/>

. . . <!-- additional keyPart blocks -->

</key>

. . . <!-- additional key blocks -->

</elementType>

</schema>

<alter_database>[0|1]</alter_database>

</SilkDataObjects_EntityDirectory_CreateDefinition>

Relationships between entity definitions are described in a preferred embodiment using relationship names, role names, and cardinalities. For example, a Customer entity definition may have properties for AccountID, LastName, and FirstName, and have a relationship to a CustOrder entity definition.

Properties have a name and a data type. In one embodiment, the data types include fixed-length and unbounded strings, integers, real numbers, Boolean values, dates, enumerations, and unique identifiers (UUIDs). Properties may be specified as required or optional.

Any properties that are primary keys are required properties. Primary keys may be composed of one or more properties. For example, a Customer entity definition may have a primary key composed of the LastName and FirstName properties. An entity definition specifies which of its properties make up the primary key for the definition and, optionally, other unique or nonunique keys, which are analogous to indexes in relational databases. The layout block of an entity definition specifies which properties make up the keys for the definition. The layout block can also be referred to as an entity block. The entity block references the properties and relationships that make up the entity and specifies whether the properties are required or optional and also the multiplicity of the relationships. The entity block also specifies the data store ID and the keys.

Any entity definition may describe one or more relationships with other entity definitions. A designer can specify relationships that involve multiple instances of an entity definition. That is, system 700 supports one-to-one, zero-or-one, zero-or-more, and one-or-more occurrences of an entity instance. Some examples of this kind of multiplicity include the following:

| | | |
|---|---|---|
| Required | 1 . . . 1 | This signifies that an instance of the |
| | | entity must be related to one and only |
| | | one instance of the related entity, for |
| | | example it is required that Person has |
| | | a Head. This kind of multiplicity is |
| | | usually in an aggregation relationship. |
| Optional | 0 . . . 1 | This signifies that an instance of the |
| | | entity may or may not be related to one |
| | | instance of the associated entity, for |
| | | example a Person may have zero or one spouse. |
| Zero or more | 0 . . . * | This signifies that an instance of the |
| | | entity may optionally be related to many |
| | | instances of the associated entity, for |
| | | example a student may be enrolled in zero |
| | | or more courses. |
| One or more | 1 . . . * | This signifies that an instance of the |
| | | entity must be related to at least one |
| | | instance of the related entity, for example |
| | | a sentence must contain one or more words. |

In a preferred embodiment, system 700 supports relationships between entity definitions using the following:

| | |
|---|---|
| Inheritance | Inheritance allows creation of an entity |
| | definition that is derived from another |
| | entity definition. |
| Associations | An association links two independent entity |
| | definitions. An association defines the |
| | relationship between two definitions. |
| | Associations do not have properties. |
| Association entity | An association entity definition is an |
| definitions | association relationship and an entity |
| | definition that attaches properties to the |
| | association relationship. The entity |
| | defines properties that exist only in the |
| | context of the association relationship. |
| Aggregation entity | An aggregation entity definition is a |
| definitions | definition and an aggregation (whole/part) |
| | relationship with another entity definition. |

Auto Discovery Engine

Auto Discovery Engine 704 allows an application developer to automatically discover relevant data fields from among the various data stores at design time.

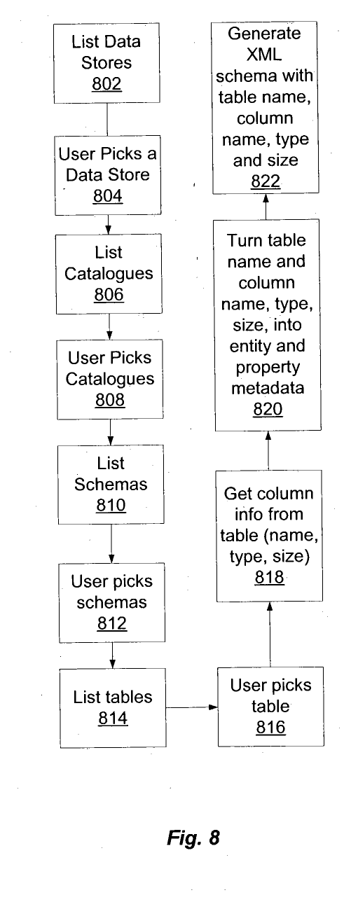

As noted, entity properties and relationships are specified by the user at design time using discovery engine 704. Referring now to FIG. 8, there is shown an example of a method for using Auto Discovery Engine 704 to create an XML Schema in accordance with an embodiment of the present invention. First, Auto Discovery Engine 704 presents 802 a list of available data stores, from which the user then selects 804 one. Where required by the data store, such as with SQL Server and Sybase data stores, the Auto Discovery Engine 704 lists 806 catalogues that are available. After the user selects 808 a catalogue, or after the user selects the data store, if a catalogue selection is not required, she is next presented 810 with a list of schemas, which again she selects 812 from. Next, Auto Discovery Engine 704 presents 814 the user with tables stored in the schema, and the user selects 816 the table of interest.

Auto Discovery Engine 704 next obtains 818 column information from the selected table. In a preferred embodiment, column information includes the name, type and size of each column. Next, Auto Discovery Engine 704 turns 820 the table name, column name, type, and size into entity and property metadata. Finally, Auto Discovery Engine 704 generates 822 an XML schema with the table name, column name, type and size data. This XML schema is then saved to Internal Design Repository 710.

Consider the following example, based on a scenario in which a first data store is an IBM DB2 Database (DB2db01), and a second data store is an Oracle Database (Oracledb02). The DB2 Database contains a table with customer information and the Oracle Database contains a table with Order information.

In this example, the customer information in the DB2db01 data store is in a table named “cust_table” with the following makeup:

| Column Name | Data Type | Column Size | Nullable |
|---|---|---|---|
| ID (pk) | VARCHAR | 25 | NO |
| FIRSTNAME | VARCHAR | 700 | NO |
| LASTNAME | VARCHAR | 700 | NO |
| AGE | NUMBER | 22 | YES |

A user can then use the Auto Discovery Engine 704 to create a schema for an entity to represent this data. The user selects the appropriate data store and schema, and then indicates the “Customer” table. The Auto Discovery 704 engine interrogates the data store to get the column names, types, sizes, nullability, primary key, and indexes. The column names, types, and sizes are represented by “elementType” elements that have the value “property” for the “is” attribute. The primary key and indexes are represented by “key” elements that have the “type” attribute of “PRIMARY”, “UNIQUE”, or “NONUNIQUE” for primary key, unique indexes, and non-unique indexes respectively. The following is an example of a schema produced for the example “Customer” table:

<schema name=“Customer” persistentname=“cust_table”>

<elementType id=“id” is=“property” persistentname=“id”>

<dataType dt=“string” maxlength=“25”/>
<description>The User ID</description>
<label locale=“ENUS”>User ID</label>

</elementType>
<elementType id=“firstName” is=“property” persistentname=“fir

stName”>

<dataType dt=“string” maxlength=“700”/>
<description>First Name</description>
<label locale=“ENUS”>First Name</label>

</elementType>
<elementType id=“lastName” is=“property” persistentname=“last

Name”>

<dataType dt=“string” maxlength =“700”/>
<description>Last Name</description>
<label locale=“ENUS”>Last Name</label>

</elementType>
<elementType id=“age” is=“property” persistentname=“age”>

<dataType dt=“int” maxlength=“”/>
<description>Age in years</description>
<label locale=“ENUS”>Age</label>

</elementType>
<elementType is=“entity” virtual=“0” id=“Customer”>

<key type=“PRIMARY”>

<keyPart href=“id”/>

</key>
<datasource>jdbc/DB2db01</datasource>
<dbschema>PrimarySchema</dbschema>
<label locale=“ENUS”>Customer</label>
<description>Customer</description>
<element type=“id” occurs=“REQUIRED”/>
<element type=“firstName” occurs=“REQUIRED”/>
<element type=“lastName” occurs=“REQUIRED”/>
<element type=“age” occurs=“OPTIONAL”/>

</elementType>

</schema>

The Order information in the Oracledb02 data store is in a table named “order_table” with the following makeup:

| Column Name | Data Type | Column Size | Nullable |
|---|---|---|---|
| ORDERID (pk) | NUMBER | 22 | NO |
| ORDERDATE | DATE | 7 | NO |
| TOTAL | REAL | 7 | YES |
| COMMENTS | VARCHAR2 | 250 | YES |

The Auto Discovery Engine 704 can again be used to point at the OracleDB02 data store to produce the schema for an entity to represent this data. The entity can be given a name like “Order” and an example of the resulting schema is as follows:

<schema name=“Order” persistentname=“order_table”>

<elementType id=“orderID” is=“property” persistentname-“orde

rID”>

<dataType dt=“int” dc=“sequencenumber” maxlength=“”/>
<description>Unique Order ID </description>

<label locale=“ENUS”>Order ID</label>

</elementType>
<elementType id=“orderDate” is=“property”
persistentname=“or

derDate”>

<dataType dt=“date” maxlength=“”/>
<description>Date order placed</description>
<label locale=“ENUS”>Order Date</label>

</elementType>
<elementType id=“total” is=“property”
persistentname= “total”>

<dataType dt=“r8” maxlength=”/>
<description>Total Cost</description>
<label locale=“ENUS”>Total Cost</label>

</elementType>
<elementType id=“comments” is=“property”
persistentname=“co

mments”>

<dataType dt=“string” maxlength=“250”/>
<description>Misc Comments</description>
<label locale=“ENUS”>Order Comment</label>

</elementType>
<elementType is=“entity” virtual=“1”
abstract=“0” id=“Order”>

<key type=“PRIMARY”>

<keyPart href=“orderID”/>

</key>
<datasource>jdbc/Oracledb02</datasource>
<dbschema>OrderSysSchema</dbschema>
<label locale=“ENUS”>Order</label>
<description>Order</description>
<element type=“orderID” occurs=“REQUIRED”/>
<element type=“orderDate” occurs=“REQUIRED”/>
<element type=“total” occurs=“OPTIONAL”/>
<element type=“comments” occurs=“OPTIONAL”/>

</elementType>

</schema>

Once the two entities are defined, an association between the two entities can be created. An example of the request to create an association between the Customer entity and the Order entity is as follows:

<schema name=“Order.placedBy” persistentname=“OrderplacedBy$”>

<elementType id=“Customer.id” from=“Customer” is=“property”>

<description>The User ID</description>
<dataType dt=“string” maxlength=“25” />

</elementType>

<elementType id=“Order.orderID” from=“Order” is=“property”>

<description>Unique Order ID</description>

<dataType dt=“int” dc=“sequencenumber” />

</elementType>

<elementType id=“Order” type=“ass ciation” is=“relationship”>

<element id=“placedBy” type=“Order.placedBy”

occurs=“OPTIONAL” />

</elementType>

<elementType id=“Customer” type=“association” is=“relationship”>

<element id=“places” type=“Order.placedBy”

occurs=“ZEROORMORE” />

</elementType>

<elementType id=“Order.placedBy” virtual=“0” is=“association”>

<entity type=“Customer” />
<entity type=“Order” />

<datasource>jdbc/DB2db01</datasource>
<dbschema>PrimarySchema</dbschema>

<description/>

</elementType>
<ancestors/>
<descendents/>

</schema>

This request will create a table in the DB2db01 data store to store that will contain foreign keys to both the Customer and Order entities in order to store the association instance data.

The association table (or join table) “OrderplacedBy$” has the following makeup:

| | Data | Column | Null- |
|---|---|---|---|
| Column Name | Type | Size | able |
| PLACESCUSTOMERID$ (pk) | VARCHAR2 | 25 | NO |
| PLACEDBYORDERORDERID$ (pk) | NUMBER | 22 | NO |

The “placesCustomerID$” column is a foreign key to the customer table and the “placedByOrderOrderID$” column is a foreign key to the Order table.

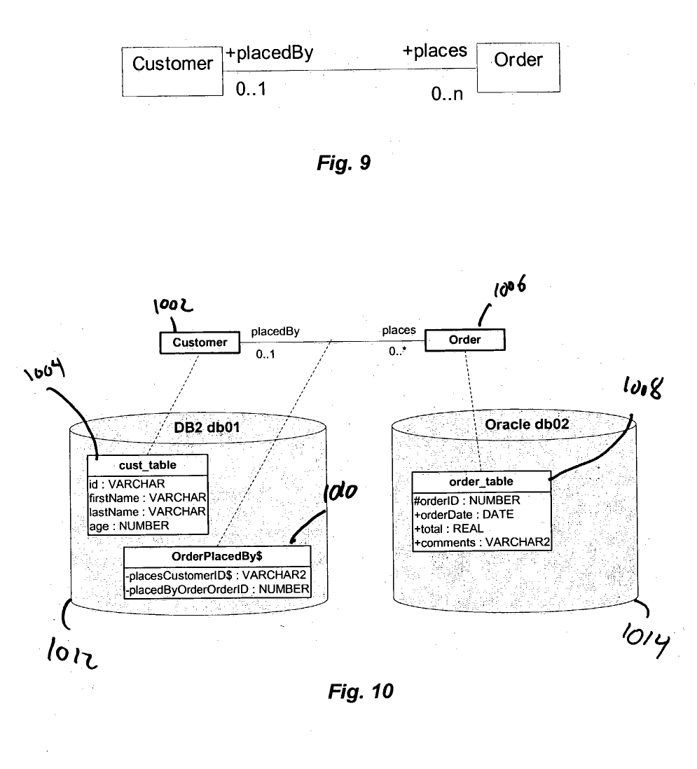

Now there is a schema that represents the following logical UML object model, as illustrated in FIG. 9.

The model shown in FIG. 10 illustrates how the logical model maps to the data model. Customer object 1002 maps to the cust_table table 1004 in the DB2db01 data store 1012, and has its instances stored as rows there. Order object 1006 mapes to the order_table table 1008 in the Oracledb01 data store 1014, and has its instance data stored as rows there. The association between the Customer 1002 and Order 1006 objects is represented by instances in the OrderPlacedBy$ table 1010 in the DB2db01 data store 1012.

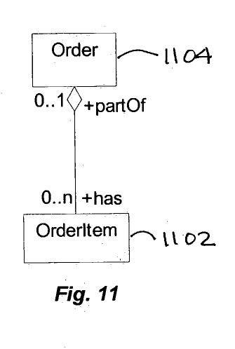

FIG. 11 presents an example of an aggregation that shows a foreign key. The OrderItem object 1102 is aggregated by the Order object 1104. As in UML terminology, this means that instances of OrderItems are contained by Orders, or an Order is made up of OrderItems. This requires some way to map OrderItems to Orders, and in this case it is achieved through using a foreign key to Orders in the table representing OrderItems instances. This can be seen as a “foreignKey” element within the “elementType” element with an ID of “partOf” that represents the “partOf” association.

<CreateDefinition>

<schema name=“OrderItem”>

<elementType from=“Order” id=“Order.orderID”
is=“property”>

<description>Unique Order ID
</description>
<dataType dc=“sequencenumber” dt=“int”/>

</elementType>
<elementType id=“ItemID” is=“property”
persistentname=“Item

ID”>
<description>Unique Item ID</description>
<dataType dt=“int”/>
<label locale=“ENUS”>Item ID</label>

</elementType>
<elementType id=“Name” is=“property”
persistentname=“Name”

>

<description>Name</description>
<dataType dt=“string” maxlength=“50”/>
<label locale=“ENUS”>Name</label>

</elementType>
<elementType id = “UnitPrice” is=“pr perty”
persistentname=“Uni

tPrice”>
<description>Price per Unit</description>

<dataType dt=“r8”/>
<label locale=“ENUS”>Unit Price</label>

</elementType>
<elementType id=“numItems” is=“property”
persistentname=“nu

mItems”>
<description>Number of Items Ordered</description>
<dataType dt=“int”/>
<label locale=“ENUS”>Number Ordered</label>

</elementType>
<elementType id=“partOf” is=“relationship” type=“parent”>

<foreignKey range=“Order”>

<Key original=“id”
persitentname=“OrderorderID$”/>

</foreignKey>

</elementType>
<elementType id=“Order” is=“relationship” type= “aggregation”

>
<element id=“has” occurs=“ZEROORMORE”
type=“OrderIte
m”/>

</elementType>
<elementType id=“OrderItem” is=“entity”
type=“aggregation” vi

rtual=“1”>
<entity type=“Order”/>
<description>OrderItem</description>
<element occurs=“REQUIRED” type=“ItemID”/>
<element occurs=“REQUIRED” type=“Name”/>
<element occurs=“REQUIRED” type=“UnitPrice”/>
<element occurs=“REQUIRED” type=“numItems”/>
<element occurs=“OPTIONAL” type=“partOf”/>
<key id=“OrderItem” type=“PRIMARY”>

<keyPart href=“Order.orderID”/>
<keyPart href=“ItemID”/>

</key>
<label locale=“ENUS”>OrderItem</label>
<datasource>jdbc/Oracledb02</datasource>
<dbschema>OrderSysSchema</dbschema>

</elementType>
<ancestors/>
<descendents/>

</schema>

</CreateDefinition>

Internal Design Repository

Once the schema is submitted for an entity or association either manually or through Auto Discovery Engine 704, it is then stored in the Internal Design Repository 710 for use when constructing create, read, update and delete statements. In one embodiment, this data store can simply be XML representations such as those described above. In alternative embodiments, it is possible to store this information in database tables and cache some of it at run time. Those of skill in the art will appreciate that this XML schema is translatable to information in database tables for faster access.

Schema Modification Examples

The following are some examples of schema modification operations. The deletion of a schema removes that schema form the Internal Design Repository 710. Manual schema update operations result in the modification of the schema in the Internal Design Repository 710 as well as the execution of the appropriate Data Definition Language (DDL) calls on the data store 708 where the entity instance data is stored. These DDL calls are generally SQL “ALTER TABLE” statements. One embodiment of the invention does not drop the physical tables in a data store when an entity definition is deleted. This is to prevent critical data from being lost by accident; deleting the schema definition from the repository essentially makes the system “forget” about the data. If desired, the physical tables can subsequently be removed manually.

In one embodiment, the general syntax to delete an entity definition schema is as follows:

<DeleteEntityDefinition>

<entity>

entity-name

</entity>

</DeleteEntityDefinition>

This results in the Schema XML representing the entity “entity-name” being removed from the Internal Design Repository 710 along with any association Schema representing associations to or from that entity. The general syntax to modify an entity definition schema is:

<UpdateEntityDefinition>

<schema name=“entity-name”>

<!-- elementType block declaring parent -->
<!-- required for derived entity definitions -->
<elementType id=“parent-entity” is=“entity”/>
<!-- relationship block -->
<!-- required for aggregate entity definitions -->
<elementType id=“parent-entity” type=“aggregation”
is=“relationship”>

<element id=“aggregate-from-parent-role”

type=“aggregate-entity”
occurs=“aggregate-from-parent-cardinality”/>

</elementType>
<!-- property block -- 1 per property -->
<elementType id=“property-name” is=“property”>

<description>field-name</description>
<lexicon/>
<string/>
<dataType dt=“string”
maxlength=“integer-value”/>
<!-- additional blocks, depending on
property type -->

</elementType>

.
.
.

<!-- entity block -- 1 required -->
<elementType id=“entity-name” is=“entity”
action=“MODIFY”>

<description>descriptive text</description>
<element type=“property-name”
occurs=“cardinality”

action=[add|modify|remove]/>

. . . <!-- additional element blocks -->

<key id=“key-name” type=“key-type”>

<keyPart href=“property-name”/>

. . . <!-- additional keyPart
blocks -->

</key>

. . . <!-- additional key blocks -->

</elementType>

</schema>

</UpdateEntityDefinition>

Examples of modifications to the Entity schema definitions are detailed below.

The following is an example of how to add a “title” property to a “Customer” entity in accordance with one embodiment of the present invention:

<UpdateEntityDefinition>

<schema name=“Customer” timecached=“”>

<elementType id=“title” is=“property” persistentname=“title”>

<dataType dt=“string” maxlength=“10”/>
<description>title</description>
<label locale=“ENUS”>title</label>

</elementType>
<elementType id=“Customer” is=“entity”
virtual=“1” action=“MO

DIFY”>
<element type=“title” occurs=“OPTIONAL”
action=“ADD”/>

</elementType>

</schema>

</UpdateEntityDefinition>

The main “entity” element that is the “elementType” block that has the same ID as the entity, (Customer in this case), is the place where modifications will be indicated. In this example, there is an “element” with the “type” of title that has an action “ADD”. This refers to the elementType that describes the title property and indicates that it should be added to the Schema XML in the Internal Design Repository 710. Once the system updates the internal design repository, it emits a SQL “ALTER TABLE ADD COLUMN” command to the data stores that contains the physical table for the entity.

The following is an example of how to add increase the maximum length of the “title” property in accordance with one embodiment of the present invention:

<SilkDataObjects_EntityDefinition_Set>

<schema name=“Customer” timecached=“”>

<elementType id=“title” is=“property”
persistentname=“title”>

<description>title</description>
<dataType dt=“string” maxlength=“25” />
<label locale=“ENUS”>title</label>

</elementType>
<elementType id =“Customer” is=“entity” virtual=“1”
action=“MO

DIFY”>

<element occurs=“OPTIONAL” type=“title”
action =“MODIFY”

/>

</elementType>

</schema>

</SilkDataObjects_EntityDefinition_Set>

The main entity block in this example has an “element” with the “type” of title that has the action “MODIFY”. This refers to the elementType that describes the title property and indicates that it should be modified in the Schema XML in the Internal Design Repository 710. The Schema will be updated with this definition of the title property. Once the design repository has been updated, the system will emit a SQL “ALTER TABLE” statement to change the length of the table column that represents the property.

The following is an example of how to remove the “title” property from the “Customer” entity in accordance with one embodiment of the present invention:

<SilkDataObjects_EntityDefinition_Set>

<schema name=“Customer” action=“REBUILD”>

<elementType id=“title” is=“property”
persistentname=“title”>

<description>title</description>
<lexicon/>
<string/>
<dataType dt=“string” maxlength=“25”/>
<label locale=“ENUS”>title</label>

</elementType>
<elementType id=“Customer” is=“entity” virtual=“1”
action=“MO

DIFY”>

<element occurs=“OPTIONAL” type=“title”
action=“REMOVE

”/>

</elementType>

</schema>
<alter_database>1</alter_database>

</SilkDataObjects_EntityDefinition_Set>

The main entity block in this example has an “element” with the “type” of title that has the action “REMOVE”. This refers to the elementType that describes the title property and indicates that it should be removed from the Schema XML in the Internal Design Repository 710. The Schema will be updated with the title property removed.

In the above example, the REBUILD action is optionally used to indicate whether to affect the table or just the schema. Without the REBUILD action the Schema in the Internal Design Repository 710 will be updated but nothing will be done to the underlying table representing the Customer entity in the DB2db01 data store. Thus the data in the table will be unaffected and the deleted column will remain in the data store but the system will ignore the existence of the column. If the REBUILD action is set then system 700 will emit a SQL “ALTER TABLE” statement that will remove the column from the table representing the Customer entity so that the data store matches the Internal Design Repository 710.

Database Abstraction

To access data stored in data objects, a client 706 creates queries that use property sets, filters, and views. The client 706 can specify these query components dynamically or create stored definitions to preserve particular queries.

To generate database specific SQL statements, system 700 uses Database Abstraction layer (the DBAbstraction) 712. To use the DBAbstraction 712 to generate an SQL INSERT statement, a combination of a SQLInsert and zero or more SQLColumn objects is used to construct the object representation of the INSERT statement. The SQLInsert is then passed into the SQLBridge object created with the database connection acquired from the database associated with the specified entity. The SQLBridge then generates the syntactically correct INSERT statement for that database.

To generate a SQL UPDATE or a SQL DELETE statement, the DBAbstraction is used in an analogous manner. Instead of constructing a SQLInsert, a SQLUpdate or a SQLDelete is constructed instead. In addition, a SQLWhere can be used to add a WHERE clause to the SQL.

Once the model is created, the entities can be used. As an example, an instance of a Customer entity can be created in a preferred embodiment with the following request:

<CreateInstance>

<Customer>

<id>dmatrix</id>
<firstName>Dot</firstName>
<lastName>Matrix</lastName>
<age>45</age>

</Customer>

</CreateInstance>

From this request, system 700 can determine that the request is to create an instance of the Customer entity. By traversing the request XML, system 700 can see that the request is to create an instance of the Customer entity and values are supplied for the id, firstName, lastName, and age properties. From the Internal Design Repository 710 (see the schema XML for Customer, above), it can be determined that the types for the ID, firstName, lastName, and age properties are string, string, string, and int, respectively. These data types and values can be used to create SQLColumn objects that will be added to a SQLInsert Object. The SQLBridge portion of the DBAbstraction 712 will then translate the SQLInsert object to the appropriate SQL statement for the DB2db01 data store that is indicated in the Customer schema. For the described embodiment, an example of the SQL is:

INSERT INTO cust_table(id, firstName, lastName, age)

VALUES(‘dmatrix’,‘Dot’,‘Matrix’, 45)

The general format for a “CreateInstance” call in a preferred embodiment is:

<CreateInstance>

<entity-name>

<element-name>element-value</element-name>

.
.
.

<relationship-name>

<entity-name>

<element-name>element-value</element-name>

.
.
.

</entity-name>

</relationship-name>

</entity-name>
<relatedKeys>0|1</relatedKeys>

</CreateInstance>

Since there is an instance of a Customer, it is possible to create an Order that was placed by that Customer, and the request will look like:

<CreateInstance>

<Order>

<orderDate>2003-6-17TO:0:0</orderDate>
<total>3.1415</total>
<comments>An Order of Pi</comments>
<placedBy>

<Customer.Key>

<id>dmatrix</id>

</Customer.Key>

</placedBy>

</Order>

</CreateInstance>

The system can see that this is a request to create an instance of an Order, and from the associated schema can also ascertain that this is creating an instance of the “placedBy” association which is from Order to Customer. The schema indicates that the Order data is stored in the OracleDB02 data store and the association data is stored in the DB2db01 data store. Using the schema and with the aid of the DBAbstraction 712, two SQL statements are constructed and executed against the two data stores. In a preferred embodiment, they are:

The Order in data store Oracledb02:

INSERT INTO order_table(orderID, orderDate, total)

VALUES(1, 2003-6-17, 3.1415)

The association in data store DB2db01:

INSERT INTO orderplacedBy$(placedByorderorderID$, placesCustomerid$) VALUES(1, dmatrix)

An example of the recursive nature of the algorithm is:

<CreateInstance>

<Customer>

<id>jdoe</id>
<firstName>John</firstName>
<lastName>Doe</lastName>
<age>35</age>

<places entity=“Order” action=“add”>

<Order>

<orderDate>2003-6-18TO:0:0</orderDate>
<total>55.60</total>
<comments>Some Stuff</comments>

</Order>

</places>

</Customer>

</CreateInstance>

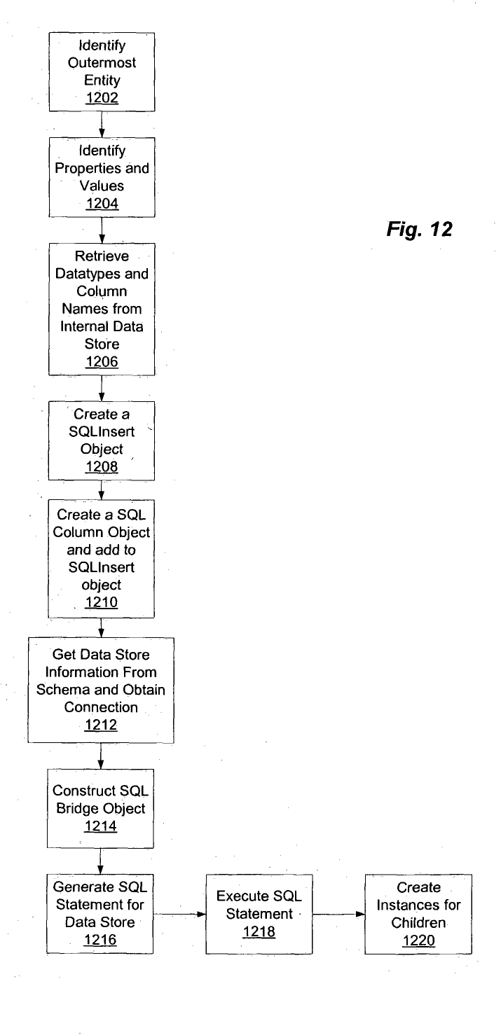

In general, and referring now to FIG. 12, an algorithm for creating instances is as follows—specifics for the example above appear in parentheses:

1. Identify 1202 the outer most entity using the outer tag name. (Customer).

2. Identify 1204 the properties and their values by iterating through the child XML elements (id=j doe, firs tName=john, lastName=Doe, age=35)

3. Retrieve 1206 the datatypes and column names for the properties from the Internal DataStore. (id=string:id firstName=string:firstname, lastName=strig:lastName, age=int:age)

4. Create 1208 a SQLInsert object.

5. Create 1210 a SQLColumn object for each property, supplying the column name, data type, and value for each (shown in #2 and #3) and add them to the SQLInsert object.

6. Get 1212 the data store information from the schema (DB2db01 for Customer) and obtain a connection to the data store.

7. Construct 1214 a SQLBridge object using the data store

8. Pass 1216 the SQLInsert to the SQLBridge to generate the appropriate SQL statement for the data store.

9. Execute 1218 the SQL statement and store the primary key for the new instance created, retrieving any auto generated values.

10. For each child XML element that is an association rather than a property 1220 (the places element)

a. Identify the entity that an instance will be created for (Order)

b. Repeat steps 2-9. (Insert an Order)

c. Use the keys from the outer insert and this inner insert to correctly insert the association using the association table or appropriate foreign key column indicated by the schema for the association.

d. Repeat step 10

The SQL statements generated for this example would be:

The Order in Oracledb02:

INSERT INTO cust_table(id, firstName, lastName, age)

VALUES(‘jdoe’,‘John’,‘Doe’, 35)

The Order in Oracledb02:

INSERT INTO order_table(orderID, orderDate, total)

VALUES(4, 2003-6-18, 55.60)

The association in DB2db01:

INSERT INTO OrderplacedBy$(placedByorderorderID$, placescustomerid$) VALUES(4, jdoe)

The same basic algorithm applies for update and delete commands, only SQLUpdate and SQLdelete objects are used instead of SQLInsert.

The syntax for the update and delete commands for instances may be, for example:

<UpdateInstance>

<entity-name>

<property-name action=[ADD|REPLACE|REMOVE]>
element-value</property-

name>

.
.
.

<relationship-name action= [ADD|REMOVE] >

<entity-name.Key>

<property-name>element-value</property-name>

</entity-name.Key>

</relationship-name>

</entity-name>
<entity-name.Key>

<property-name>key-value</property-name>

.
.
.

</entity-name.Key>
<relatedKeys>0|1<relatedKeys>

</UpdateInstance>
<DeleteInstance>

<entity>entity-name</entity>
<entity-name.Key>

<instance-name>instance-value</instance-name>

</entity-name.Key>

</DeleteInstance>

Query Example:

At run time, a user of client workstation 706 wishes to access objects stored in multiple data stores 708. The Database Abstraction 712 generates properly formed SQL using the following steps according to one embodiment. First, a connection to the datasource is acquired, and this connection is passed on to the abstraction object SQLBridge. The abstraction queries the connection to determine the database vendor and version. The abstraction then uses this information to load into the SQLBridge object database/version specific XML containing the syntactical differences of that database that differ from the SQL92 standard. The application will use the abstraction to create objects specific to the operation desired. For example, if a SELECT operation is required, an SQLCommand object is created. This object is then composed of an SQLSelect object, an SQLFrom object an optional SQLWhere object, an optional SQLOrderBy object and an optional SQLGroupBy object. The combination of these objects defines the generic behavior expected by the application for a Select operation. The application then requests a syntactically correct SQL command from the SQLBridge object by passing the SQLCommand object into the SQLBridge object. The SQLBridge object will then be able to apply the database specific differences to the SQL command as it generates the correct SQL based on the expected behavior defined in the SQLCommand object. Once the SQLBridge has generated the syntactically correct SQL command it will then be executed on the connection associated with that database/datasource. Any new databases can have their syntactical differences defined in the database abstraction XML. That XML will be loaded the first time the application passes a connection from that datasource to the SQLBridge object. This greatly simplifies the normally code intensive task of maintaining compliance with multiple different databases in the same code base.

To access data stored in data objects, a client 706 creates queries that use property sets, filters, and views. The client 706 can specify these query components dynamically or create stored definitions to preserve particular queries.

The XML for a query includes in a preferred embodiment a “propertyset” and a filter. The propertyset identifies the properties that should be returned as the results of the query and the filter specifies the constraints to place on the results as in a SQL WHERE clause.

For example, the following query retrieves the first name and last name of the customer in a preferred embodiment, as well as the order information for that customer if the customer's ID is “dmatrix”, and if there are any orders with a total greater than “$5.00” or an order date greater than or equal to “2003-6-17T0:0:0”.

Since the entities are in two different data stores, multiple SQL statements will be executed to get the appropriate data, then the data will be combined and returned.

<QueryInstances>

<query entity=“Customer” id=“AdHocView”>

<propertyset entity=“Customer” id=“adHoc”>

<property id=“firstName” />

<property id=“lastName” />
<property entity =“Order” id=“places”>

<property id=“orderDate” />
<property id=“total” />

</property>

</propertyset>
<filter entity=“Customer” id=“AdhocFilter”>

<conditions required=“ALL”>

<property id=“id” operator=“EQ”
value=“dmatrix”

/>

</conditions>
<property entity=“Order” id=“places”

joinType=“INNER”>
<conditions required=“1 OR 2”>

<property id=“total” operator=“GT”

value=“5.00” />

<property id=“orderDate”
operator=“GE”

value=“2003-6-17” />

</conditions>

</property>

</filter>

</query>

</QueryInstances>

As with the insert algorithm described above, the algorithm for processing the query XML is also recursive. The above query will be used to illustrate the algorithm.

1. Merge the properties from the filter into the propertyset to create a single propertyset. Any associations traversed in the propertyset will default to LEFT OUTER joins unless overridden in the propertyset or the filter. Associations traversed in the filter will default to INNER joins.

<propertyset entity=“Customer” id=“adHoc” required=“ALL”>

<property id=“firstName” />
<property id=“lastName” />
<property id=“id” operator=“EQ” value=“dmatrix”/>
<property entity=“Order” id=“places” joinType=“INNER”

required=“1 OR 2”>

<property id=“orderDate” />
<property id=“total” />
<property id=“total” operator=“GT” value=“5.00” />
<property id=“orderDate” operator=“GE”

value=“2003-6-17” />

</property>

</propertyset>

2. Begin by setting the “current XML position” indicator to the outer propertyset element.

3. Begin maintaining an array of SQL statements, which include SELECT, FROM, and WHERE portions and create the first empty SQL statement in position 0.

4. Initialize a variable to 0 that indicates the “working SQL statement”.

5. Get the name of the starting entity from the current XML position (Customer) and get the data store (DB2db01) and table name (cust_table) from the schema in the Internal Design Repository 710. Make note of the data store and add the table name to the FROM portion of the working SQL statement.

(FROM cust_table)

6. Get the primary key columns for the entity form the schema and add them to the SELECT portion of the SQL statement for use when merging SQL statements.

(SELECT Customer$1.id)

7. Add a unique alias to the table name using the entity name:

(FROM cust_table Customer$1)

8. Iterate through all of the property elements that do not represent associations and are not part of the filter (indicated by an “operator” attribute) and for each:

a. Use the property name to lookup the column name from the schema for the entity.

b. Add the column to the SELECT portion of the working SQL statement.

(SELECT Customer$1.id ,Customer$1.firstName, Customer$1.lastName

FROM cust_table Customer$1)

9. Get the value of the “required” attribute from the current XML position (set in #2)—this will indicate how to combine the conditions in the WHERE clause:

ALL: indicates use “AND” between all conditions.

ANY: indicates use “OR” between all conditions.

The other option is a complex condition that refers to the property conditions by number like “(1 OR 2) AND (3 OR 4)”

10. Begin maintaining a WHERE clause array.

11. Iterate through all of the property elements from the filter (indicated by an “operator” attribute) and for each

a. Use the property name to lookup the data type and column name from the schema.

b. Get the operator and value attributes and combine them with the column name to construct a condition for the WHERE clause. Add this to the WHERE clause array. The array in this case will be:

0: Customer$1.id=‘dmatrix'

12. Using the value of the required attribute and the conditions in the WHERE clause array, add the conditions to the WHERE clause of the working SQL statement:

(SELECT Customer$1.id,Customer$1.firstName,

Customer$1.lastName

FROM cust_table Customer$1
WHERE Customer$1.id=‘dmatrix’)

13. Iterate through all of the property elements that represent associations and for each:

a. Get the association schema from the Internal Design Repository.

b. Get the “joinType” attribute value from the element and add the join to the FROM portion of the working SQL statement

(SELECT Customer$1.id,Customer$1.firstName,

Customer$1.lastName

FROM cust_table Customer$1

INNER JOIN OrderplacedBy$ Order$placedBy$1 ON

(Customer$1.id =

Order$placedBy$1.placesCustomerid$)

WHERE Customer$1.id =‘dmatrix’)

c. Get the name of the entity on the other side of the association using the “entity” attribute of the property element or from the association schema. (Order)

d. Set the “current XML position” to this association property element

e. Get the name of the data store from the schema for the associated entity. (OracleDB02)

f. If the data store is the same as the previous entities data store then and proceed from step #5 above. (not the case in this example)

g. Else if the data store is different than the previous entity then add a new SQL statement to the array of SQL statements, store the fact that this SQL statement is a sub-query to the current “working SQL statement” (0 in this case), then increment the variable that indicates the “working SQL statement”, and now proceed from step #5 above.

14. One completed, there will be an array of SQL statements with some of the statements being sub-queries to previous statements. The statements are preferably executed in order, and when data store boundaries are traversed the parent statement should select the foreign keys from the association table and then merge them into the WHERE clause for the sub-statements. Then the sub-statement results can be merged with the parent statement results using the primary key values from the instances and the association instances.

The array for this example looks as follows in a preferred embodiment:

0:

SELECT

Customer$1.id,Customer$1.firstName,Customer$1.lastName,

Order$placedBy$1.placedByOrderorderID$

FROM cust_table Customer$1

INNER JOIN OrderplacedBy$ Order$placedBy$1 ON

(Customer$1.id =

Order$placedBy$1.placesCustomerid$)

WHERE (Customer$1.id = ‘dmatrix’)

1: <sub-query to 0>

SELECT Order$1.orderID,Order$1.orderDate,Order$1.total
FROM order_table Order$1
WHERE Order$1.total > 5.00

OR Order$1.orderDate >= 2003-06-17

ORDER BY Order$1.id

The results of the first query will be:

| | | | |
|---|---|---|---|
| dmatrix | Dot | Matrix | 1 |
| dmatrix | Dot | Matrix | 2 |
| dmatrix | Dot | Matrix | 3 |

The foreign keys to Order Will then be added to the sub-SQL statement for Orders as follows:

SELECT Order$1.orderID,Order$1.orderDate,Order$1.total
FROM order_table Order$1
WHERE ( Order$1.total > 5.00

OR Order$1.orderDate >= 2003-06-17)

AND ( Order$1.ordered = 1 OR Order$1.ordered = 2 OR

Order$1.ordered = 3)

ORDER BY Order$1.id

The results will be:

| | | |
|---|---|---|
| 2 | 2003-06-20 | 75.25 |
| 3 | 2003-06-18 | 3.1415 |

These results will be merged with the previous results using an “INNER JOIN” type mechanism as indicated in the query, therefore since Order #1 did not meet the Order criteria the Customer row containing that order will be removed. The combined results will be:

| | | | | | |
|---|---|---|---|---|---|
| dmatrix | Dot | Matrix | 2 | 2003-06-20 | 75.25 |
| dmatrix | Dot | Matrix | 3 | 2003-06-18 | 3.1415 |

The result will then be converted to XMl and returned as follows:

<view id=“AdHocView” entity=“Customer”>

<viewitem>

<Customer.Key>

<id>dmatrix</id>

</Customer.Key>
<Customer>

<firstName>Dot</firstName>
<lastName>Matrix</lastName>
<places>
<Order.Key>

<orderID>2</orderID>

</Order.Key>
<Order>

<orderDate>2003-06-20</orderDate>
<total>75.25</total>

</Order>

</places>
<places>

<Order.Key>

<orderID>3</orderID>

</Order.Key>
<Order>

<orderDate>2003-06-18</orderDate>
<total>3.1415</total>

</Order>

</places>

</Customer>

</viewitem>

</view>

Responding to Data Store Schema Changes

Since system 700 allows data to be manipulated across multiple data stores 708, it is important to be able to automatically react to schema changes in these data stores. Referring to the previous example, if additional columns were added to the order_table table in the Oracle database (presumably by the party responsible for this database and application), system 700 can detect these new columns in the data store schema and add them to the object model implemented by the invention.

As noted above, system 700 includes a Synchronizer module 716 that synchronizes the object model repository with any changes in the schemas of the underlying data stores. The Synchronizer 716 can preferably be invoked in a number of ways: manually or periodically by an automatic program (e.g. daily). Once invoked, the Synchronizer 716 calls the Auto Discovery Engine 704 on the tables in each data store 708, which returns schema definitions for each table. (See the earlier description of the Auto Discovery Engine 704 for examples of these schema definitions.) Then the Synchronizer 716 determines the set of differences between the schema definitions in the Internal Design Repository 710 and the schema definitions produced by Auto Discovery Engine 704. We do not describe the algorithm for computing the difference between the schemas; there are several published sources for this algorithm, such as XMLdiff, which is well known in the art.

Once Synchronizer 716 has the difference sets, it can go about synchronizing the repository schemas with the current schemas in-the data store 708 using the following algorithm. If a property appears in a data store schema but does not appear in the repository schema, then the Synchronizer 716 adds the property to the repository schema. If a property appears in the repository schema but not in the data store schema, then it is removed from the repository schema. Finally, if the property exists in both schemas but the property type is different, the Synchronizer 716 sets the repository's property type to the new property type. Note that the Synchronizer 716 does not have to change any physical database tables here; the change has already been made before the Synchronizer discovered it.

In order to handle associations properly, the Synchronizer preferably processes the schemas for all Entities before it processes the schemas for association tables. This allows system 700 to detect the case where the primary key of an Entity has changed so that it is no longer compatible with the foreign key in an association table. The Synchronizer 716 signals an exception to the user in this case.

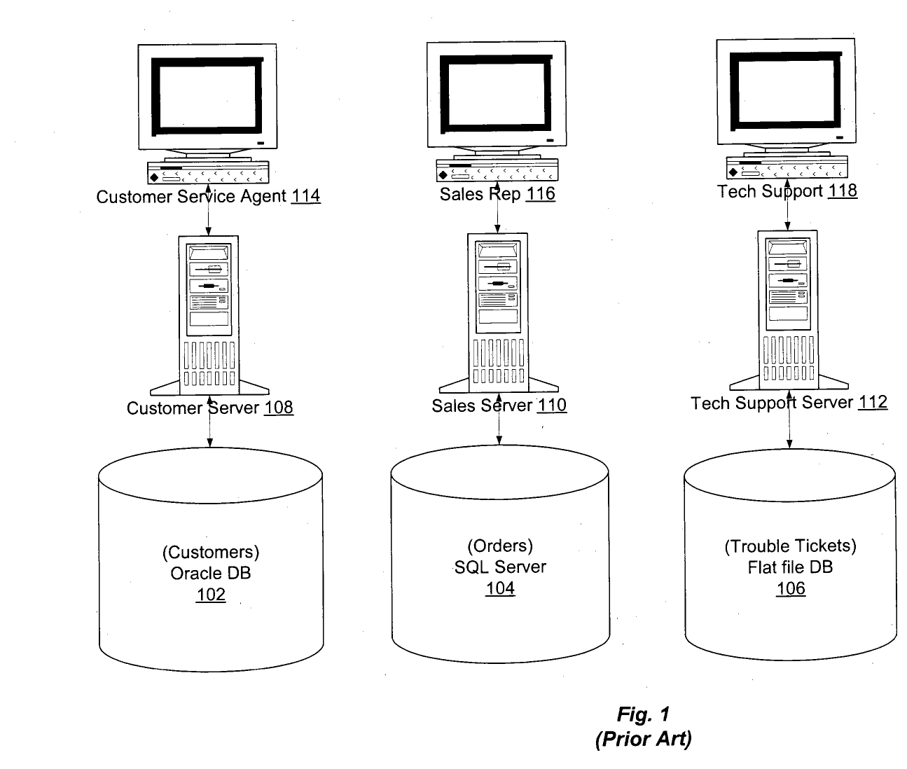

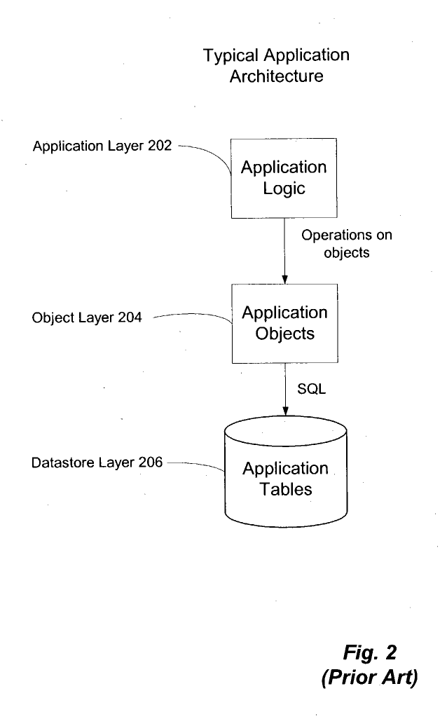

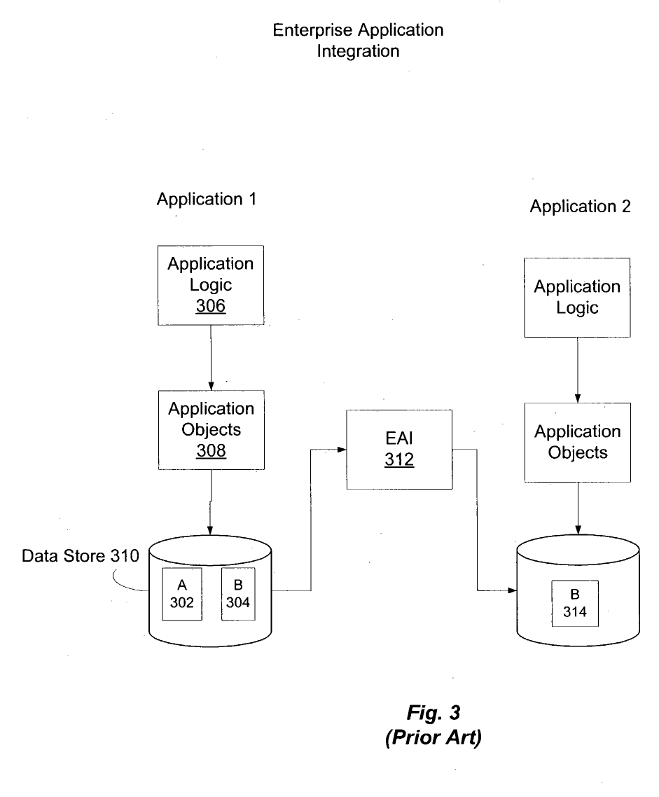

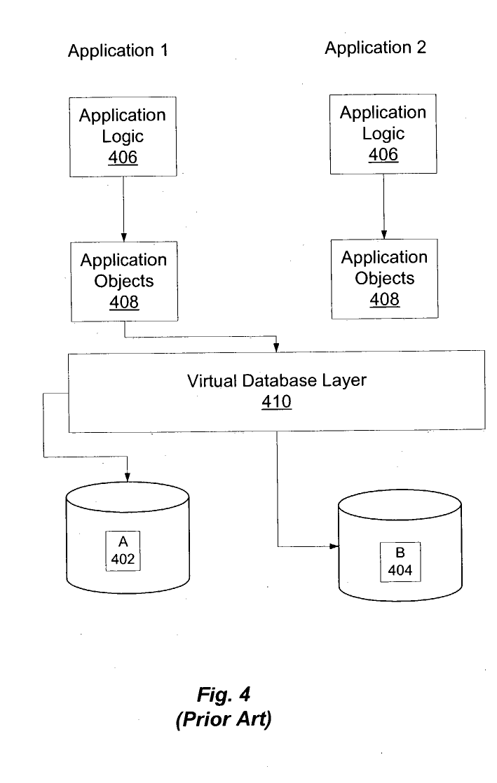

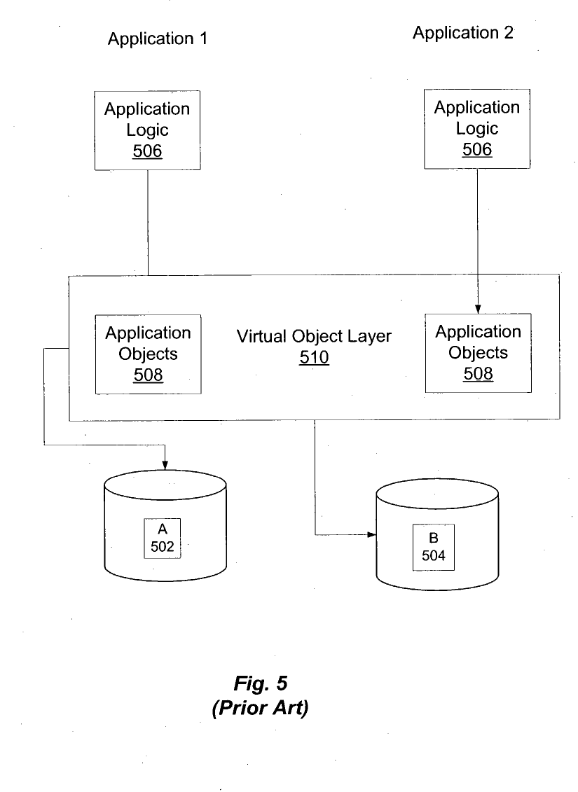

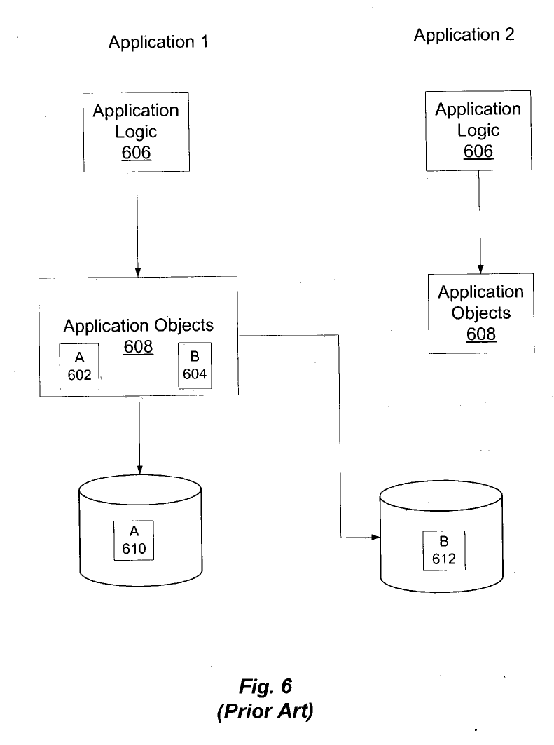

Accordingly, using the present invention, it is possible to map objects across multiple types of data stores as described above. Consider the enterprise described above with respect to FIG. 1, in which customer data is stored on customer database 102, and order data is stored on an SQL server 104. The customer service agent 114 wants to be able to access order data through the main system. In a preferred embodiment of the invention, the agent 114 can use the user interface provided by the CSR agent's local client software to select a data source, in this case SQL server 104, and once the orders table has been brought into the Oracle database 102, a relationship can be defined between customers in customer database 102 and orders that are not stored in that database. Subsequently, data manipulation can be carried out at the object level by the agent without difficulty, because the entire relationship is viewable and can be manipulated in a single logical view. The present invention enables a client to manipulate a single object, even though the object comprises data from a plurality of data stores. As the object is updated, the updates are translated into updates to the individual objects in the different data stores.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component. For example, the particular functions of the Database Abstraction, Auto Discovery Engine, and so forth may be provided one or more modules.

Some portions of the above description present the feature of the present invention in terms of algorithms and symbolic representations of operations on information. These algorithmic descriptions and representations are the means used by those skilled in the casino management arts to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein.. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A method for automatically generating an XML schema for mapping objects across multiple different data stores, the method comprising:
receiving a selection of a data store;
displaying a list of schemas available on the data store;
receiving a selection of one of the listed schemas;
displaying a list of tables stored in the selected schema;
receiving a selection of one of the listed tables;
determining entity and property metadata associated with the selected table; and
generating an XML schema using the determined metadata.

2. The method of claim 1 further comprising:
responsive to receiving a selection of the data store:
displaying a list of catalogues that are available on the data store; and
receiving a selection of one of the listed catalogues.
